(19) United States
(12) Patent Application Publication
(10) Pub. No.: US 2008/0070682 A1
(43) Pub. Date: Mar. 20, 2008

(54) SYSTEMS AND METHODS FOR PROVIDING EDUCATIONAL GAMES FOR USE BY YOUNG CHILDREN, AND DIGITAL STORAGE MEDIUMS FOR STORING THE EDUCATIONAL GAMES THEREON

(75) Inventor: Michael J. Woody, Arlington, WA (US)

Correspondence Address: NIXON & VANDERHYE, P.C., 901 NORTH GLEBE ROAD, 11TH FLOOR, ARLINGTON, VA, 22203, US

(73) Assignee: Nintendo of America Inc., Redmond, WA (US)

(21) Appl. No.: 11/839,291

(22) Filed: Aug. 15, 2007

Related U.S. Application Data
(60) Provisional application No. 60/837,618, filed on Aug. 15, 2006.

(51) Int. Cl. A63F 13/00; A63F 9/24

(52) U.S. Cl. 463/30; 463/32; 463/43

(57) ABSTRACT

Systems and methods are provided that enable young children (e.g., toddlers to pre-kindergarten aged children) and/or persons with disabilities to easily play, and effectively learn from, interactive, educational, and entertaining games. The edutainment game may be a series of instructions stored on a digital storage medium for use with a game system. The young child or person with a disability may play the game using a wireless, handheld controller that is easily graspable, maneuverable, and manipulatable, and the young child or person with a disability may play the game alone or with supervision from another person. The edutainment games may include one or more learning tools (or learning games), emphasizing skills such as, for example, color, shape, and/or sound recognition; puzzle-solving; navigation; number recognition, counting, and/or ordering; alphabet and reading/writing; etc. These skills may be emphasized individually or in various combinations.

### CROSS-REFERENCE TO RELATED APPLICATION

This application claims the benefit of U.S. Application Ser. No. 60/837,618, the entire contents of which are hereby incorporated herein by reference.

### FIELD

The example embodiments described herein relate to game programs and digital mediums for storing the game programs. More particularly, the example embodiments described herein relate to systems and methods that provide interactive, educational, and entertaining games that young children and/or persons with disabilities can play easily and learn from effectively.

### BACKGROUND AND SUMMARY

Personal game systems have revolutionized entertainment in the home. Conventional game systems generally include a console configured to display an interactive game on a television. A user (e.g., a game player) generally can interact with a game by using a controller operably connected to the game system to, for example, control a player character within a virtual world. In some games, a number of game players can play a game at the same time, either cooperatively or competitively.

Games can be classified as belonging to one of many genres, including, for example, action-adventure games, puzzle games, strategy games, role-playing games, first-person shooting games, sports games, racing games, etc. It will be appreciated that this list of game genres is provided by way of example and without limitation. It also will be appreciated that this classification of games is not exact, and that games in general actually tend to span one or more categories. The specifics of the games vary wildly but, in general, all of the games are provided for the enjoyment of the game player. Additionally, the games may be targeted to certain age groups. For example, first-person shooting games may be appropriate for generally older audiences because of the realistic violence depicted therein, while games based on popular cartoons may be appropriate for younger audiences. Sports games may be appropriate for all ages.

As noted above, some games can be enjoyed by multiple game players. Taking advantage of this feature, some games have been designed specifically for use by families. For example, instead of sitting around and playing a board game, a family might participate in a game played in conjunction with the game console. This may provide more interactive enjoyment to a whole family playing together, regardless of whether they are playing cooperatively or competitively.

As an incident of playing a game, either individually or in a group, a game player may increase hand-eye coordination and fine motor skills. Strategy games and problem-solving games also may help develop critical thinking and reasoning skills. Games played with a group of game players may encourage team-work and cooperation. It will be appreciated that other side-benefits of games have been realized and, in fact, taken into account by developers when designing games.

In view of these advantageous aspects of games, game developers eventually realized that games could be provided for more than just entertainment. Thus, educational entertainment games became popular, and the field of “edutainment” was spawned. Edutainment games have included trivia style games, reading games, and the like. Some of the best-selling edutainment games have combined many conventional forms of pure entertainment games with traditional pedagogical principals. Some of the best edutainment games may instruct and provide benefits without the game player even realizing that the game player is receiving an education.

While edutainment and family-oriented games have been known, and while their beneficial aspects have been noted and sometimes praised, there are a number of drawbacks associated with such games and their game systems and further refinements are still possible. For a number of reasons, such games can reach only a limited audience. For example, as noted above, game players interact with game systems using controllers. These game controllers frequently are large and ill-suited for young children's hands. Additionally, as games become more and more complicated, so too have the controllers become more complicated. Typical controllers may include at least one analog joystick, a digital cross-switch, multiple depressable buttons, control buttons, etc. Clearly, young children (especially toddlers and pre-kindergarten children) will encounter difficulties using such complicated apparatuses. Thus, these difficulties may arise because of the physical dimensions of the controllers in relation to the size of the child's hands, complicated operation of controllers, etc. These problems may be compounded because young children may still be developing hand-eye coordination and fine-motor skills. Thus, numerous barriers may prevent children from enjoying edutainment games, even when such edutainment games merely are computerized versions of conventional paper-and-pencil or board games. Indeed, the trend is to make controllers larger and more complicated to facilitate more advanced gaming.

These disadvantages are not only applicable to toddlers and other young children. For example, any person with reduced dexterity would encounter similar challenges. This group includes people with small hands (toddlers, children, etc.), as well as people with disabilities. Currently, many people with disabilities cannot play games because of the complicated controllers, difficult game interfaces, general problems translating gross motor movements into fine motor controls, etc.

One commercially successful approach for providing edutainment products has been to provide an input mechanism directly on a touch screen. For example, a stylus or finger may be applied to a touch screen interface. However, this approach generally is not available on game systems that employ regular displays that are not configured for use with a separate touch screen device. Moreover, this approach does little to cultivate developmental gross and fine motor skills.

Also, even if this approach were successfully implemented on normal displays associated with game systems, a further complication would arise based at least in part on the location, angle, orientation, and perspective from which a game player would interact with the game system. In particular, toddlers often are shorter than their displays and thus cannot directly provide input thereto. Moreover, even if they could, they would be have to strain upwardly to access the display from below, potentially resulting in physical discomfort along with a technical difficulties associated with accommodating and/or offsetting input in connection with the angle or perspective of input.

Thus, it will be appreciated that there is a need in the art to overcome one or more of the above-noted problems. In accordance with one exemplary illustrative embodiment, systems and methods are provided that enable young children to easily play, and effectively learn from, interactive, educational, and entertaining games.

One aspect of certain exemplary illustrative embodiments is that the edutainment game may be appropriate for, and usable by, a toddler to pre-kindergarten aged youth. The edutainment game may be used by the child alone, and/or with supervision from another (e.g., a parent, sibling, friend, etc.).

Another aspect of certain exemplary illustrative embodiments relates to providing a wireless, handheld controller easily graspable, maneuverable, and manipulatable by a young child. In this way, the game player may navigate through, and learn from, the game.

Still another aspect of certain exemplary illustrative embodiments relates to providing young children with one or more learning tools. Such learning tool may emphasize skills such as, for example, color, shape, and/or sound recognition; puzzle-solving; navigation; number recognition, counting, and/or ordering; alphabet; and reading/writing, etc. These skills may be emphasized individually or in various combinations. It will be appreciated that the above-listed skills are given by way of example and without limitation.

In certain exemplary illustrative embodiments, a game system capable of executing a game program stored on a computer readable storage medium is provided. A stationary display is configured to display output from the game program. A handheld pointing controller is configured to detect an orientation thereof and is configured to provide indirect user interaction with a simplified graphical user interface displayed on the display. The controller is easily manipulable and includes at least one button or trigger. The user interaction includes game object selection and/or manipulation from a plurality of user locations and/or perspectives proximate to the display. The controller is operable substantially only with a gross motor movement of the user. The game program is arranged so as to convey to the user at least one lesson or skill.

In certain other exemplary illustrative embodiments, a computer-readable storage medium tangible embodying a game program for use with a game system having a handheld pointing controller configured to detect an orientation thereof, is provided. Display programmed logic circuitry is configured to display output from the game program to a stationary display. Controlling programmed logic circuitry is configured to receive input from the controller and is configured to provide indirect user interaction with a simplified graphical user interface of the game program displayable on the display. The controller is easily manipulable and includes at least one button or trigger. The user interaction includes game object selection and/or manipulation from a plurality of user locations and/or perspectives proximate to the display. The controller is operable substantially only with a gross motor movement of the user. The game program is arranged so as to convey to the user at least one lesson or skill.

Such programmed logic circuitry may be any suitable combination of hardware, software, firmware, and/or the like.

These aspects, features, advantages, and embodiments may be provided in various combinations to realize yet further embodiments.

### BRIEF DESCRIPTION OF THE DRAWINGS

These and other features and advantages will be better and more completely understood by referring to the following detailed of exemplary illustrative non-limiting implementations in conjunction with the drawings, of which:

FIG. 1 is a diagram of an example illustrative non-limiting game system;

FIG. 2 is a block diagram of example game system shown in FIG. 1;

FIGS. 3A and 3B are perspective views of a top and a bottom of example controller shown in FIG. 1;

FIG. 4 is a front view of example controller shown in FIG. 1;

FIG. 5 is a block diagram of example controller shown in FIG. 1;

FIG. 6 is a view showing a young child interacting with the game system of FIG. 1;

FIG. 7 is an example animal-matching learning game in accordance with an exemplary illustrative embodiment;

FIG. 8 is an example number-matching learning game in accordance with an exemplary illustrative embodiment;

FIG. 9 is an example letter-matching learning game in accordance with an exemplary illustrative embodiment;

FIG. 10 is an example tile-matching learning game in accordance with an exemplary illustrative embodiment;

FIG. 11 is an example maze learning game in accordance with an exemplary illustrative embodiment;

FIG. 12 is an example shape-matching game in accordance with an exemplary illustrative embodiment;

FIG. 13 is an example bed-making game in accordance with an exemplary illustrative embodiment;

FIG. 14 is an example tooth-brushing game in accordance with an exemplary illustrative embodiment;

FIG. 15 is an example reading game in accordance with an exemplary illustrative embodiment;

FIG. 16 is an example pet feeding game in accordance with an exemplary illustrative embodiment;

FIG. 17 is an example pet car game in accordance with an exemplary illustrative embodiment;

FIG. 18 is an example gardening game in accordance with an exemplary illustrative embodiment;

FIG. 19 is an example zoo outing game in accordance with an exemplary illustrative embodiment; and,

FIG. 20 is an example additional hardware component that may be used in connection with certain exemplary embodiments.

### DETAILED DESCRIPTION

1. Example Hardware Components of Exemplary Illustrative Game Systems

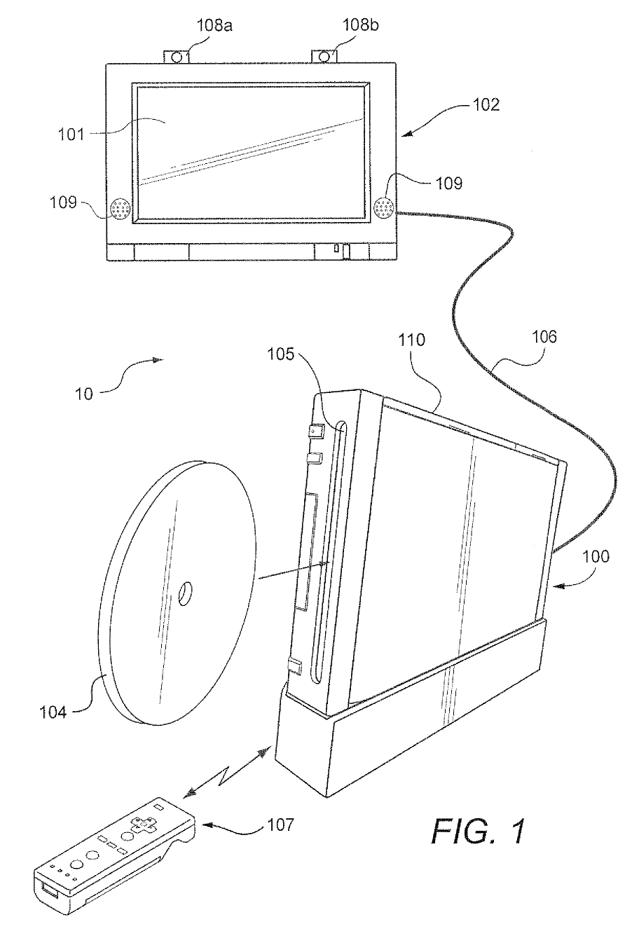

Referring now more particularly to the drawings, FIG. 1 shows a non-limiting example game system 10, including a game console 100, a television 102, and a controller 107.

Game console 100 executes a game program or other application stored on optical disc 104 inserted into slot 105 formed in housing 110 thereof. The result of the execution of the game program or other application is displayed on display 101 of television 102 to which game console 100 is connected by cable 106. Audio associated with the game program or other application is output via speakers 109 of television 102. While an optical disk is shown in FIG. 1, the game program or other application may alternatively or additionally be stored on other storage media, such as, for example, semiconductor memories, magneto-optical memories, magnetic memories, and the like.

Controller 107 wirelessly transmits data, such as game control data, to the game console 100. The game control data may be generated using an operation section of controller 107 having, for example, a plurality of operation buttons, a key, a stick and the like. Controller 107 also may wirelessly receive data transmitted from game console 100. Any one of various wireless protocols, such as, for example, Bluetooth (registered trademark) may be used for the wireless transmissions between controller 107 and game console 100.

As discussed below, controller 107 also includes an imaging information calculation section for capturing and processing images from light-emitting devices 108a and 108b. Although markers 108a and 108b are shown in FIG. 1 as being above television 100, they also may be positioned below television 100. In one implementation, a center point between light-emitting devices 108a and 108b is substantially aligned with a vertical center-line of television 101. The images from light-emitting devices 108a and 108b can be used to determine a direction in which controller 107 is pointing as well as a distance of controller 107 from display 101. By way of example and without limitation, light-emitting devices 108a and 108b may be implemented as two LED modules (hereinafter, referred to as “markers”) provided in the vicinity of a display screen of television 102. The markers each output infrared light, and the imaging information calculation section of controller 107 detects the light output from the LED modules to determine a direction in which controller 107 is pointing and a distance of controller 107 from display 101 as mentioned above. As will become apparent from the description below, various implementations of the system and method for simulating the striking of an object described herein do not require use such markers.

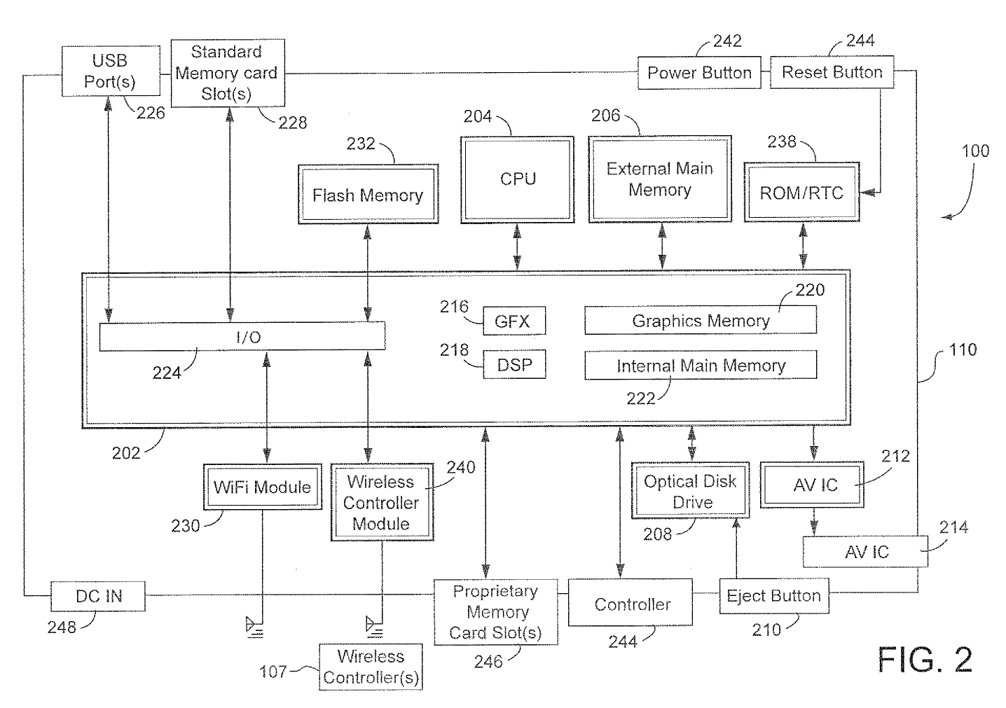

With reference to the block diagram of FIG. 2, game console 100 includes a RISC central processing unit (CPU) 204 for executing various types of applications including (but not limited to) video game programs. CPU 204 executes a boot program stored in a boot ROM (not shown) to initialize game console 100 and then executes an application (or applications) stored on optical disc 104, which is inserted in optical disk drive 208. User-accessible eject button 210 provided on housing 110 of game console 100 may be used to eject an optical disk from disk drive 208.

In one example implementation, optical disk drive 208 receives both optical disks of a first type (e.g., of a first size and/or of a first data structure, etc.) including applications developed to take advantage of the capabilities of CPU 204 and graphics processor 216 and optical disks of a second type (e.g., of a second size and/or a second data structure) including applications originally developed for execution by a CPU and/or graphics processor having capabilities different than those of CPU 204 and/or graphics processor 216. For example, the optical disks of the second type may be applications originally developed for the Nintendo GameCube platform.

CPU 204 is connected to system LSI 202 that includes graphics processing unit (GPU) 216 with an associated graphics memory 220, audio digital signal processor (DSP) 218 internal main memory 222 and input/output (I/O) processor 224.

I/O processor 224 of system LSI 202 is connected to one or more USB ports 226, one or more standard memory card slots (connectors) 228, WiFi module 230, flash memory 232, and wireless controller module 240.

USB ports 226 are used to connect a wide variety of external devices to game console 100. These devices include, by way of example and without limitation, game controllers, keyboards, storage devices (such as, for example, external hard-disk drives, printers, digital cameras, etc.), and the like. USB ports 226 may also be used for wired network (e.g., LAN) connections. In one example implementation, two USB ports 226 are provided.

Standard memory card slots (connectors) 228 are configured to receive industry-standard-type memory cards (e.g., SD memory cards). In one example implementation, one memory card slot 228 is provided. These memory cards generally are used as data carriers, but of course this use is provided by way of illustration, not limitation. For example, a player may store game data for a particular game on a memory card and bring the memory card to a friend's house to play the game on the friend's game console. The memory cards may also be used to transfer data between the game console and personal computers, digital cameras, and the like.

WiFi module 230 enables game console 100 to be connected to a wireless access point. The access point may provide internet connectivity for on-line gaming with players at other locations (with or without voice chat capabilities), as well as web browsing, e-mail, file downloads (including game downloads), and many other types of on-line activities. In some implementations, WiFi module may also be used for communication with other game devices, such as suitably-equipped hand-held game devices. Module 230 is referred to herein as “WiFi,” which is generally a designation used in connection with the family of IEEE 802.11 specifications. However, game console 100 may of course alternatively or additionally use wireless modules that conform to other wireless standards.

Flash memory 232 stores, by way of example and without limitation, game save data, system files, internal applications for the console, and downloaded data (such as games).

Wireless controller module 240 receives signals wirelessly transmitted from one or more controllers 107 and provides these received signals to I/O processor 224. The signals transmitted by controller 107 to wireless controller module 240 may include signals generated by controller 107 itself as well as by other devices that may be connected to controller 107. By way of example, some games may utilize separate right- and left-hand inputs. For such games, another controller (not shown) may be connected to controller 107 and controller 107 can transmit to wireless controller module 240 signals generated by itself and by the other controller.

Wireless controller module 240 may also wirelessly transmit signals to controller 107. By way of example without limitation, controller 107 (and/or another game controller connected thereto) may be provided with vibration circuitry and vibration circuitry control signals may be sent via wireless controller module 240 to control the vibration circuitry (e.g., by turning the vibration circuitry on and off). By way of further example and without limitation, controller 107 may be provided with (or be connected to) a speaker (not shown), and audio signals for output from this speaker may be wirelessly communicated to controller 107 via wireless controller module 240. By way of still further example and without limitation, controller 107 may be provided with (or be connected to) a display device (not shown), and display signals for output from this display device may be wirelessly communicated to controller 107 via wireless controller module 240.

Proprietary memory card slots 246 are configured to receive proprietary memory cards. In one example implementation, two such slots are provided. These proprietary memory cards have some non-standard feature(s), such as a non-standard connector and/or a non-standard memory architecture. For example, one or more of the memory card slots 246 may be configured to receive memory cards used with the Nintendo GameCube platform. In this case, memory cards inserted in such slots can transfer data from games developed for the GameCube platform. In an example implementation, memory card slots 246 may be used for read-only access to the memory cards inserted therein and limitations may be placed on whether data on these memory cards can be copied or transferred to other storage media such as standard memory cards inserted into slots 228.

One or more controller connectors 244 are configured for wired connection to respective game controllers. In one example implementation, four such connectors are provided for wired connection to game controllers for the Nintendo GameCube platform. Alternatively, connectors 244 may be connected to respective wireless receivers that receive signals from wireless game controllers. These connectors enable players, among other things, to use controllers for the Nintendo GameCube platform when an optical disk for a game developed for this platform is inserted into optical disk drive 208.

A connector 248 is provided for connecting game console 100 to DC power derived, for example, from an ordinary wall outlet. Of course, the power may be derived from one or more batteries.

GPU 216 performs image processing based on instructions from CPU 204. GPU 216 includes, for example, circuitry for performing calculations necessary for displaying three-dimensional (3D) graphics. GPU 216 performs image processing using graphics memory 220 dedicated for image processing and a part of internal main memory 222. GPU 216 generates image data for output to television 102 by audio/video connector 214 via audio/video IC (interface) 212.

Audio DSP 218 performs audio processing based on instructions from CPU 204. The audio generated by audio DSP 218 is output to television 102 by audio/video connector 214 via audio/video IC 212.

External main memory 206 and internal main memory 222 are storage areas directly accessible by CPU 204. For example, these memories can store an application program such as a game program read from optical disc 104 by the CPU 204, various types of data, or the like.

ROM/RTC 238 includes a real-time clock and preferably runs off of an internal battery (not shown) so as to be usable even if no external power is supplied. ROM/RTC 238 also may include a boot ROM and SRAM usable by the console.

Power button 242 is used to power game console 100 on and off. In one example implementation, power button 242 must be depressed for a specified time (e.g., one or two seconds) to turn the console off so as to reduce the possibility of inadvertently turn-off. Reset button 244 is used to reset (re-boot) game console 100.

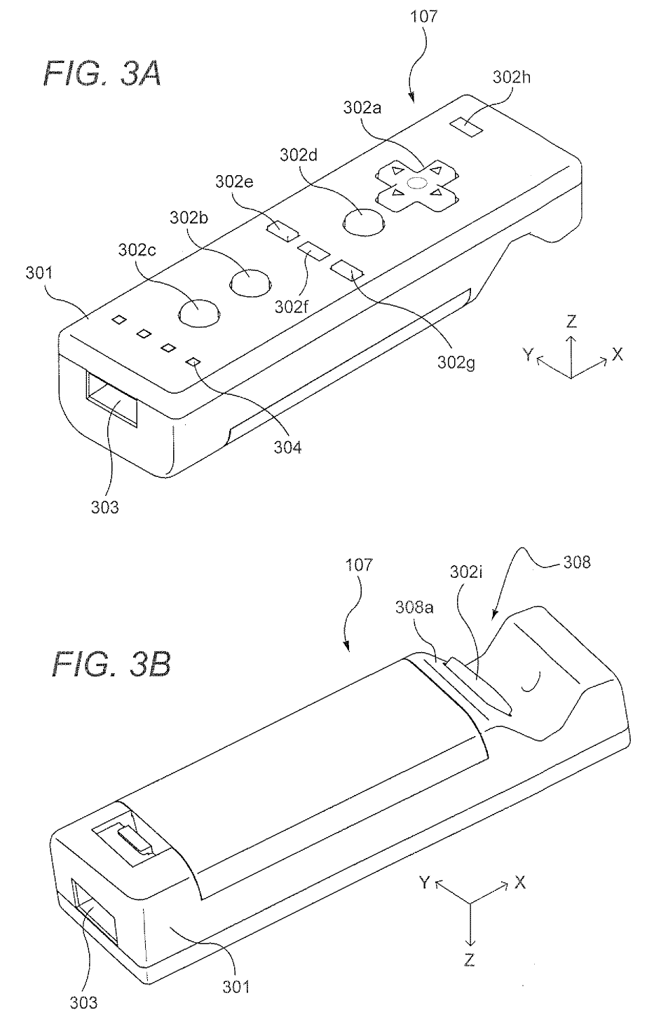

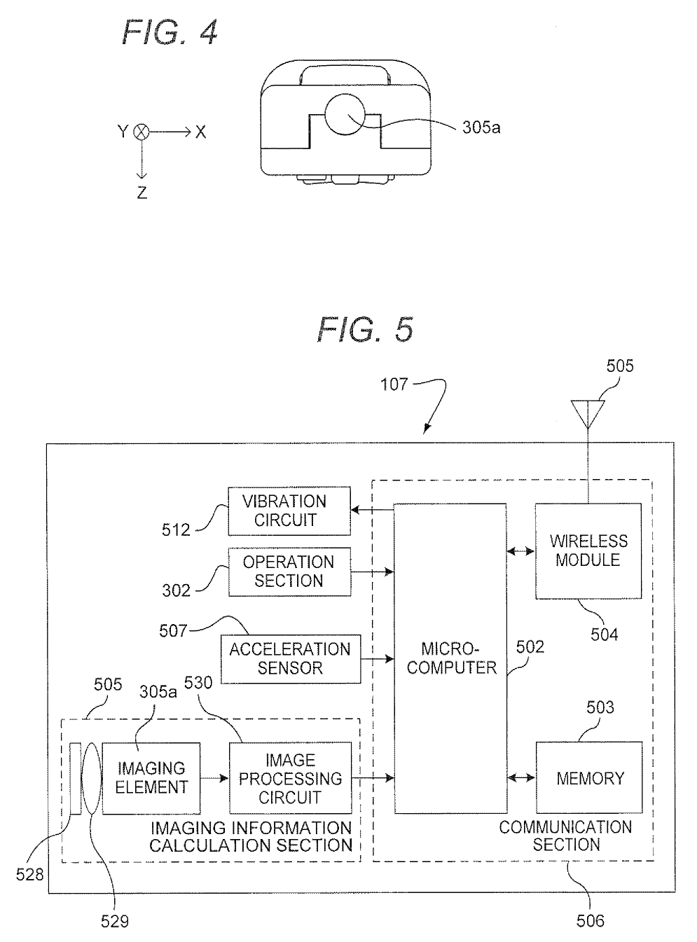

With reference to FIGS. 3 and 4, example controller 107 includes a housing 301 on which operating controls 302a-302h are provided. Housing 301 has a generally parallelepiped shape and is sized to be conveniently grasped by a player's hand. Cross-switch 302a is provided at the center of a forward part of a top surface of the housing 301. Cross-switch 302a is a cross-shaped four-direction push switch which includes operation portions corresponding to the directions designated by the arrows (front, rear, right and left), which are respectively located on cross-shaped projecting portions. A player selects one of the front, rear, right, and left directions by pressing one of the operation portions of the cross-switch 302a. By actuating cross-switch 302a, the player can, for example, move a character in different directions in a virtual game world.

Cross-switch 302a is described by way of example and other types of operation sections may be used. By way of example without limitation, a composite switch including a push switch with a ring-shaped four-direction operation section and a center switch may be used. By way of further example and without limitation, an inclinable stick projecting from the top surface of housing 301 that outputs signals in accordance with the inclining direction of the stick may be used. By way of still further example and without limitation, a horizontally slidable disc-shaped member that outputs signals in accordance with the sliding direction of the disc-shaped member may be used. By way of still further example and without limitation, a touch pad may be used. By way of still further example and without limitation, separate switches corresponding to at least four directions (e.g., front, rear, right and left) that output respective signals when pressed by a player can be used.

Buttons (or keys) 302b through 302g are provided rearward of cross-switch 302a on the top surface of housing 301. Buttons 302b through 302g are operation devices that output respective signals when a player presses them. For example, buttons 302b through 302d are respectively an “X” button, a “Y” button and a “B” button and buttons 302e through 302g are respectively a select switch, a menu switch and a start switch, for example. Generally, buttons 302b through 302g are assigned various functions in accordance with the application being executed by game console 100. In an exemplary arrangement shown in FIG. 3, buttons 302b through 302d are linearly arranged along a front-to-back centerline of the top surface of housing 301. Buttons 302e through 302g are linearly arranged along a left-to-right line between buttons 302b and 302d. Button 302f may be recessed from a top surface of housing 701 to reduce the possibility of inadvertent pressing by a player grasping controller 107.

Button 302h is provided forward of cross-switch 302a on the top surface of the housing 301. Button 302h is a power switch for remote on-off switching of the power to game console 100. Button 302h may also be recessed from a top surface of housing 301 to reduce the possibility of inadvertent pressing by a player.

A plurality (e.g., four) of LEDs 304 is provided rearward of button 302c on the top surface of housing 301. Controller 107 is assigned a controller type (number) so as to be distinguishable from other controllers used with game console 100 and LEDs 304 may be used to provide a player a visual indication of this assigned controller number. For example, when controller 107 transmits signals to wireless controller module 240, one of the plurality of LEDs corresponding to the controller type is lit up.

With reference to FIG. 3B, a recessed portion 308 is formed on a bottom surface of housing 301. Recessed portion 308 is positioned so as to receive an index finger or middle finger of a player holding controller 107. A button 302i is provided on a rear, sloped surface 308a of the recessed portion. Button 302i functions, for example, as an “A” button which can be used, by way of illustration, as a trigger switch in a shooting game.

As shown in FIG. 4, an imaging element 305a is provided on a front surface of controller housing 301. Imaging element 305a is part of an imaging information calculation section of controller 107 that analyzes image data received from markers 108a and 108b. Imaging information calculation section 305 has a maximum sampling period of, for example, about 200 frames/sec., and therefore can trace and analyze even relatively fast motion of controller 107. The techniques described herein of simulating the striking of an object can be achieved without using information from imaging information calculation section 305, and thus further detailed description of the operation of this section is omitted. Additional details may be found in Application Nos. 60/716,937, entitled “VIDEO GAME SYSTEM WITH WIRELESS MODULAR HANDHELD CONTROLLER,” filed on Sep. 15, 2005; 60/732,648, entitled “INFORMATION PROCESSING PROGRAM,” filed on Nov. 3, 2005; and application No. 60/732,649, entitled “INFORMATION PROCESSING SYSTEM AND PROGRAM THEREFOR,” filed on Nov. 3, 2005. The entire contents of each of these applications is expressly incorporated herein by reference.

Connector 303 is provided on a rear surface of controller housing 301. Connector 303 is used to connect devices to controller 107. For example, a second controller of similar or different configuration may be connected to controller 107 via connector 303 to allow a player to play games using game control inputs from both hands. Other devices including game controllers for other game consoles, input devices such as keyboards, keypads, and touchpads and output devices, such as speakers and displays may be connected to controller 107 using connector 303.

For ease of explanation in what follows, a coordinate system for controller 107 will be defined. As shown in FIGS. 3 and 4, a left-handed X, Y, Z coordinate system has been defined for controller 107. Of course, this coordinate system is described by way of example and without limitation, and the systems and methods described herein are equally applicable when other coordinate systems are used.

As shown in the block diagram of FIG. 5, controller 107 includes a three-axis, linear acceleration sensor 507 that detects linear acceleration in three directions, i.e., the up/down direction (Z-axis shown in FIGS. 3 and 4), the left/right direction (X-axis shown in FIGS. 3 and 4), and the forward/backward direction (Y-axis shown in FIGS. 3 and 4). Alternatively, a two-axis linear accelerometer that only detects linear acceleration along each of the Y-axis and Z-axis may be used or a one-axis linear accelerometer that only detects linear acceleration along the Z-axis may be used. Generally speaking, the accelerometer arrangement (e.g., three-axis or two-axis) will depend on the type of control signals desired. As a non-limiting example, the three-axis or two-axis linear accelerometer may be of the type available from Analog Devices, Inc. or STMicroelectronics N.V. Preferably, acceleration sensor 507 is an electrostatic capacitance or capacitance-coupling type that is based on silicon micro-machined MEMS (micro-electromechanical systems) technology. However, any other suitable accelerometer technology (e.g., piezoelectric type or piezoresistance type) now existing or later developed may be used to provide three-axis or two-axis linear acceleration sensor 507.

As one skilled in the art understands, linear accelerometers, as used in acceleration sensor 507, are only capable of detecting acceleration along a straight line corresponding to each axis of the acceleration sensor. In other words, the direct output of acceleration sensor 507 is limited to signals indicative of linear acceleration (static or dynamic) along each of the two or three axes thereof. As a result, acceleration sensor 507 cannot directly detect movement along a non-linear (e.g., arcuate) path, rotation, rotational movement, angular displacement, tilt, position, attitude or any other physical characteristic.

However, through additional processing of the linear acceleration signals output from acceleration sensor 507, additional information relating to controller 107 can be inferred or calculated (i.e., determined), as one skilled in the art will readily understand from the description herein. For example, by detecting static, linear acceleration (i.e., gravity), the linear acceleration output of acceleration sensor 507 can be used to determine tilt of the object relative to the gravity vector by correlating tilt angles with detected linear acceleration. In this way, acceleration sensor 507 can be used in combination with micro-computer 502 of controller 107 (or another processor) to determine tilt, attitude or position of controller 107. Similarly, various movements and/or positions of controller 107 can be calculated through processing of the linear acceleration signals generated by acceleration sensor 507 when controller 107 containing acceleration sensor 307 is subjected to dynamic accelerations by, for example, the hand of a user, as will be explained in detail below.

In another embodiment, acceleration sensor 507 may include an embedded signal processor or other type of dedicated processor for performing any desired processing of the acceleration signals output from the accelerometers therein prior to outputting signals to micro-computer 502. For example, the embedded or dedicated processor could convert the detected acceleration signal to a corresponding tilt angle (or other desired parameter) when the acceleration sensor is intended to detect static acceleration (i.e., gravity).

Returning to FIG. 5, image information calculation section 505 of controller 107 includes infrared filter 528, lens 529, imaging element 305a, and image processing circuit 530. Infrared filter 528 allows only infrared light to pass therethrough from the light that is incident on the front surface of controller 107. Lens 529 collects and focuses the infrared light from infrared filter 528 on imaging element 305a. Imaging element 305a is a solid-state imaging device such as, for example, a CMOS sensor or a CCD. Imaging element 305a captures images of the infrared light from markers 108a and 108b collected by lens 309. Accordingly, imaging element 305a captures images of only the infrared light that has passed through infrared filter 528 and generates image data based thereon. This image data is processed by image processing circuit 520 which detects an area thereof having high brightness, and, based on this detecting, outputs processing result data representing the detected coordinate position and size of the area to communication section 506. From this information, the direction in which controller 107 is pointing and the distance of controller 107 from display 101 can be determined.

Vibration circuit 512 may also be included in controller 107. Vibration circuit 512 may be, for example, a vibration motor or a solenoid. Controller 107 is vibrated by actuation of the vibration circuit 512 (e.g., in response to signals from game console 100), and the vibration is conveyed to the hand of the player grasping controller 107. Thus, a so-called vibration-responsive game may be realized.

As described above, acceleration sensor 507 detects and outputs the acceleration in the form of components of three axial directions of controller 107, i.e., the components of the up-down direction (Z-axis direction), the left-right direction (X-axis direction), and the front-rear direction (the Y-axis direction) of controller 107. Data representing the acceleration as the components of the three axial directions detected by acceleration sensor 507 is output to communication section 506. Based on the acceleration data which is output from acceleration sensor 507, a motion of controller 107 can be determined.

Communication section 506 includes micro-computer 502, memory 503, wireless module 504, and antenna 505. Micro-computer 502 controls wireless module 504 for transmitting and receiving data while using memory 503 as a storage area during processing. Micro-computer 502 is supplied with data including operation signals (e.g., cross-switch, button or key data) from operation section 302, acceleration signals in the three axial directions (X-axis, Y-axis and Z-axis direction acceleration data) from acceleration sensor 507, and processing result data from imaging information calculation section 505. Micro-computer 502 temporarily stores the data supplied thereto in memory 503 as transmission data for transmission to game console 100. The wireless transmission from communication section 506 to game console 100 is performed at predetermined time intervals. Because game processing generally is performed at a cycle of 1/60 sec. (16.7 ms), the wireless transmission is preferably performed at a cycle of a shorter time period. For example, a communication section structured using Bluetooth (registered trademark) technology can have a cycle of 5 ms. At the transmission time, micro-computer 502 outputs the transmission data stored in memory 503 as a series of operation information to wireless module 504. Wireless module 504 uses, for example, Bluetooth (registered trademark) technology to send the operation information from antenna 505 as a carrier wave signal having a specified frequency. Thus, operation signal data from operation section 302, the X-axis, Y-axis, and Z-axis direction acceleration data from acceleration sensor 507, and the processing result data from imaging information calculation section 505 are transmitted from controller 107. Came console 100 receives the carrier wave signal and demodulates or decodes the carrier wave signal to obtain the operation information (e.g., the operation signal data, the X-axis, Y-axis, and Z-axis direction acceleration data, and the processing result data). Based on this received data and the application currently being executed, CPU 204 of game console 100 performs application processing. If communication section 506 is structured using Bluetooth (registered trademark) technology, controller 107 can also receive data wirelessly transmitted thereto from devices including game console 100.

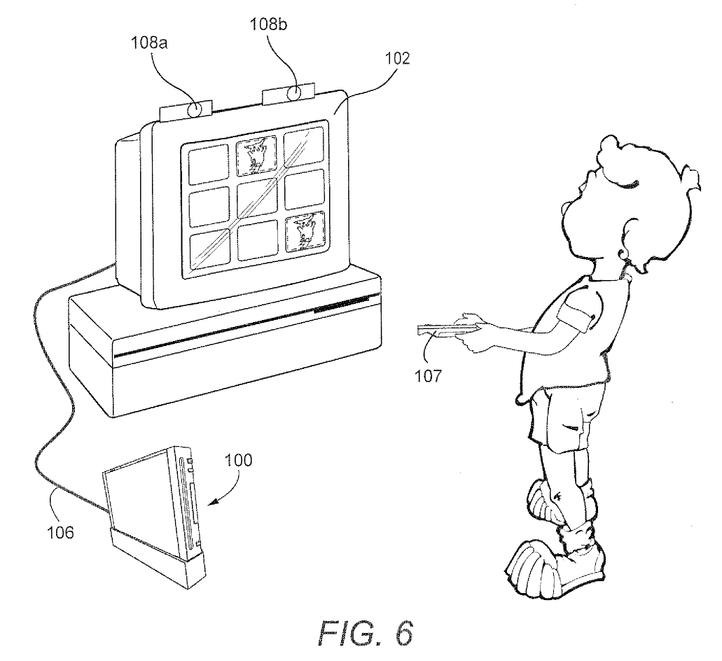

FIG. 6 is a view showing a young child interacting with the game system of FIG. 1. The young child points controller 107 at television 102. Any signals from controller 107 that are captured are transmitted to game console 100, and the signals serve as inputs into the game program being executed by game console 100. The signals are interpreted by and/or passed to the game program running on game console 100. Game console 100 outputs the appropriate display to television 102 based on, for example, an instruction from the game program.

The features of controller 107 are important to the functioning of the exemplary illustrative embodiments described herein. More particularly, it has been determined that the combination of the particular size, shape, and functionality of controller 107 described herein enables young children to interact with games and game systems in ways that conventionally are not possible.

For example, the shape and size of the controller make it easily graspable and manipulatable by a young child. Thus, minimum fine motor skills may be required to effectuate a corresponding action on television 102. This can be contrasted with typical prior art controllers, which typically include one or more analog joysticks and a digital cross-pad. Using such a prior art controller, a young child would have to adequately and accurately indicate inclination angles and inclination amounts with the one or more analog joysticks and/or a cross-switch to cause a corresponding movement of a player character and/or to effectuate a desired result during execution of the game program. This is particularly cumbersome when trying to navigate through a world, especially for a young child who may be still developing hand-eye coordination, advanced depth and shadow perception, fine motor skills, etc. However, with controller 107 described, corresponding navigation may be accomplished by left-right, forward-backward, and up-down movements of the controller itself. Such navigation may be realized by a corresponding movement of a hand, arm, or even the entire child. Thus, it has been determined that gross motor skills can be used to finely control game objects displayed on television 102.

Additionally, conventional controllers need to be gripped with two hands. However, controller 107 only needs to be gripped with one hand. This may be quite important for young children, whose hands otherwise may be too small to adequately use a conventional controller. Controller 107 even allows to hands to be used on the controller for steadying and other purposes. Indeed, a young child may maneuver and use controller 107 in a fashion substantially similar to taking and pulling on a parent's hand and squeezing the parent's finger.

Also, because some engagement of an object may need to be present by the system, the location of the switch 302i under controller 107 depressable by the index or middle finger in combination with the accompanying recession makes it easier for a child to cause a change. Again, this may be contrasted with conventional controllers, which typically require a game player to remove a thumb from an analog joystick or cross-switch to depress a button. Even when separate left and right buttons designed to be actuated by an index finger are present, a small child's hands may be too small to reach the buttons to cause a desired depression. Accordingly, the need for a large, complicated controller is reduced. As such, it has been determined that controller 107 provides a particularly advantageous control mechanism for young children, thus enabling games to be specifically tailored for young children.

This is particularly true given the ways in which a person with small hands grasps a controller. In such a case, all that is required for actuation is a single squeeze of a trigger or button proximate to an end of the controller. Moreover, the need for one or more cross-switches and/or joysticks is reduced since the controller is configured to detect its own orientation (e.g., via accelerometers, point recognition, etc.). The ease of interaction can be further increased by providing a simplified graphical user interface (GUI). Together with the controller, the game player may achieve many interesting interactions with the game program that otherwise would not be possible.

Furthermore, the controller 107 described herein may be further customized by reducing its size yet further. This may enable younger and/or smaller children to realize the same and/or similar benefits of the learning tools using the same and/or similar interface provided by the larger controller 107. Different sizes, colors, textures, etc. of the controller 107 also may be provided.

2. Exemplary Illustrative Edutainment Games

Several exemplary illustrative edutainment games will now be described. It will be appreciated that the games set forth below are provided by way of example and without limitation. Thus, it will be will be appreciated that the games presented herein may function in the manners set forth below, or with variations thereon. It also will be appreciated that any number of modifications and/or additional different edutainment games may be provided. However, providing the controller in combination with simplified, educational interfaces are generally important considerations when creating edutainment games for young children to interact with and learn from.

2.1 Exemplary Illustrative Animal-Matching Learning Game

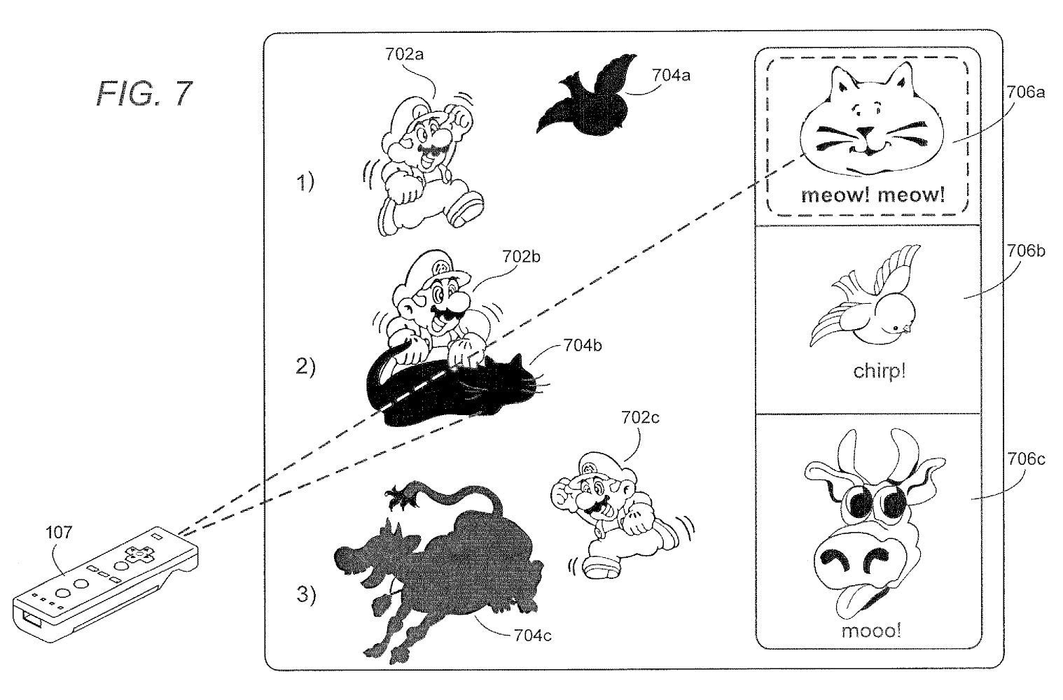

FIG. 7 is an example animal-matching learning game in accordance with an exemplary illustrative embodiment. This game may teach a child about animals, animal sounds, appropriate interactions with animals, etc. For example, it may teach a child that it is acceptable to gently pet cats, but that one generally should avoid rattlesnakes.

FIG. 7 shows a display divided into two areas. In the area to the right, a number of animals are displayed. For example, a cat is shown in area 706a, a bird is shown in area 706b, and a cow is shown in area 706c. To the left of the screen, readily recognizable non-player character 702a-c are shown interacting with shadow animals 704a-c. Thus, first non-player character 702a runs after a first shadow 704a, second non-player character 702b pets a second shadow 704b, and third non-player character 702c chases a third shadow 704c. It will be appreciated that the animals, non-player objects, and shadows are provided by way of example and without limitation. Other animals (e.g., dogs, monkeys, gazelles, vultures, meerkats, etc.) may be used, and other sounds may be emitted as appropriate, depending on, for example, the animal and/or the culture for which the game is designed (e.g., in the United States, a bird makes a “chirp chirp” or “tweet tweet” sound, whereas a bird makes a “chunchun” sound in Japan).

When a game player selects a shadow (e.g., by clicking on it, dragging on it, pointing at it and engaging a button, etc.), the shadow may make the appropriate corresponding animal sound. An animation also may be displayed (e.g., non-player character 702b may pet shadow 704b when shadow 704b is selected). If the game player correctly selects the corresponding animal from the right side, the shadow may be revealed. Additionally, a sound may indicate a correct match. After a predetermined time, for correct selections, the non-player character, the shadow, and/or the animals to the right of the screen may disappear.

Also, one or more of the non-player objects 702a-c may instruct the game player as to how to play the game, indicate whether the match is correct, show excitement and/or dismay, etc.

2.2 Exemplary Illustrative Number-Matching Learning Game

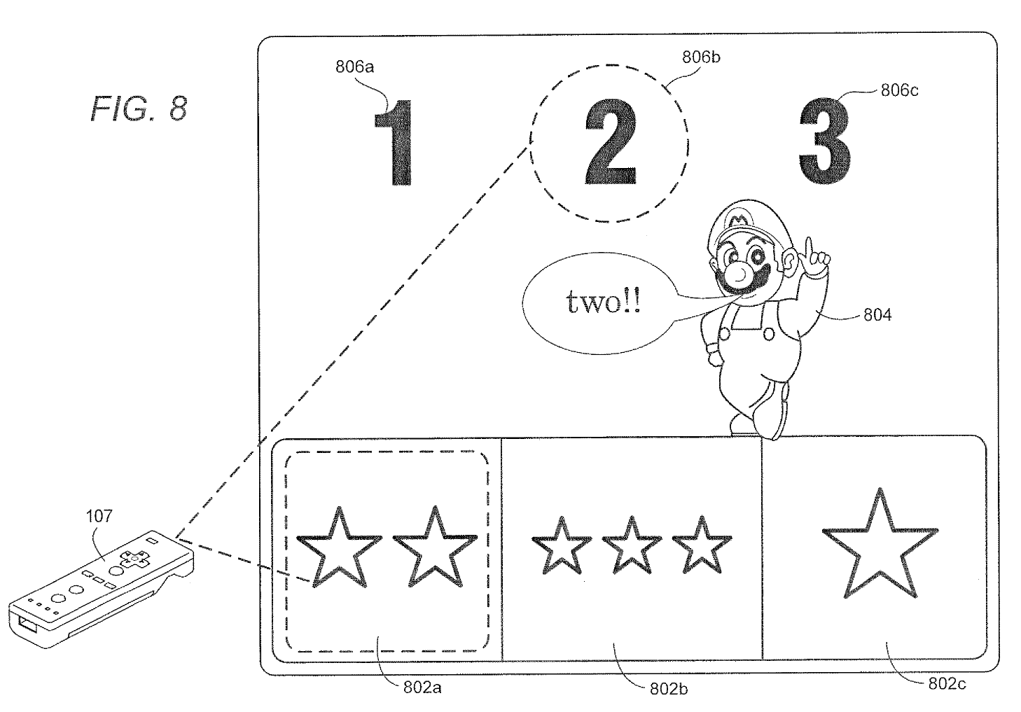

FIG. 8 is an example number-matching learning game in accordance with an exemplary illustrative embodiment. This game may help a child learn how to count, how to associate numbers with groups of objects, etc.

Different numbers of stars are grouped in the lower portion of the screen in areas 802a-c. Numbers are listed across the top of the screen in areas 806a-c. In FIG. 8, the number of stars are shown in a random order to make the matching game difficult. It will be appreciated, however, that the numbers across the top of the screen may be randomized in addition to, or rather than, the symbols at the bottom of the screen. Non-player character 804 audibly says a number (in this case “two”). In FIG. 8, non-player character 804 also holds up a corresponding number of fingers. Then, via controller 107, the player character matches the cardinal number with the corresponding number of symbols in the lower portion of the screen. The non-player object may indicate a successful match. In a variation on the game, roman numerals may be used instead of, or in addition to, the numbers and groups of objects displayed on the screen.

2.3 Exemplary Illustrative Letter-Matching Learning Game

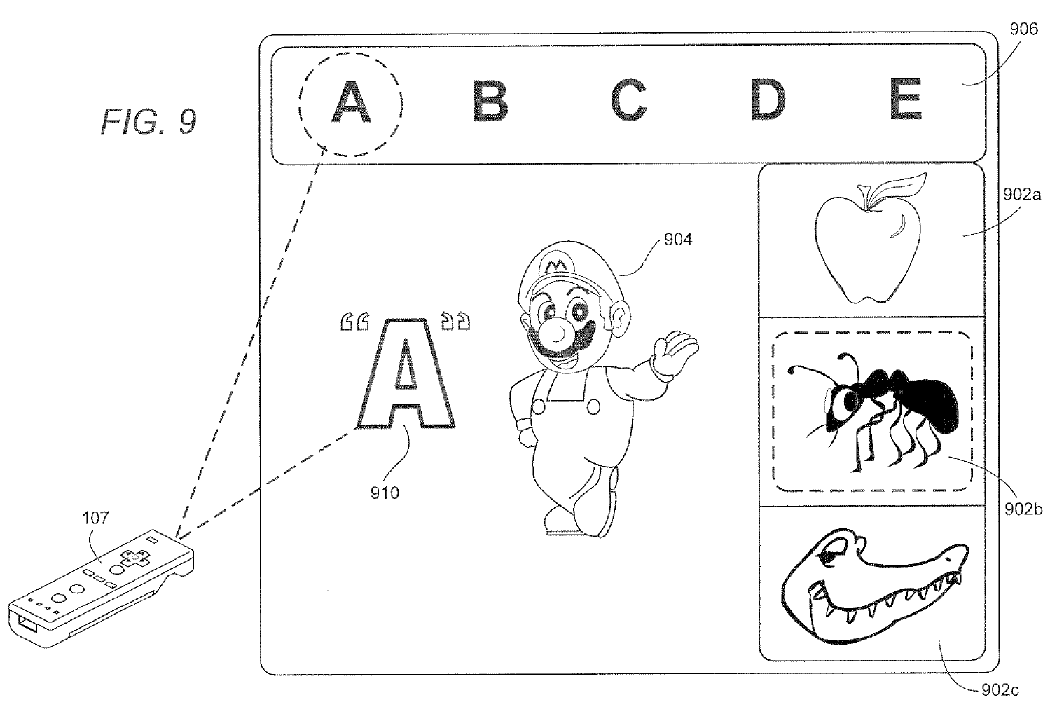

FIG. 9 is an example letter-matching learning game in accordance with an exemplary illustrative embodiment. This game may teach a child the basics of spelling (e.g., the first letter of a word).

In FIG. 9, a series of letters are displayed across the top of the screen in area 906. A number of objects are displayed on the right side of the screen in areas 902a-c—namely, an apple, an ant, and an alligator. The game player may be prompted to select the appropriate letter beginning each object in areas 902a-c from the area 906. When the proper letter is selected, non-player object 904 may say the letter selected and/or the correct letter, (e.g., to indicate whether the response is correct). Also, non-player character 904 may provide tips or hints to the game player. In certain example embodiments, the letters in area 906 may be randomly displayed, and the game player may have to order them (thus familiarizing the game player with the alphabet).

In a variation on this game, a letter may be selected from the area 906. Then, one or more objects that begin with that letter may be displayed on the right side of the screen in areas 902a-c. A game player may then have to pick the object that does not begin with the selected letter.

2.4 Exemplary Illustrative Tile-Matching Learning Game

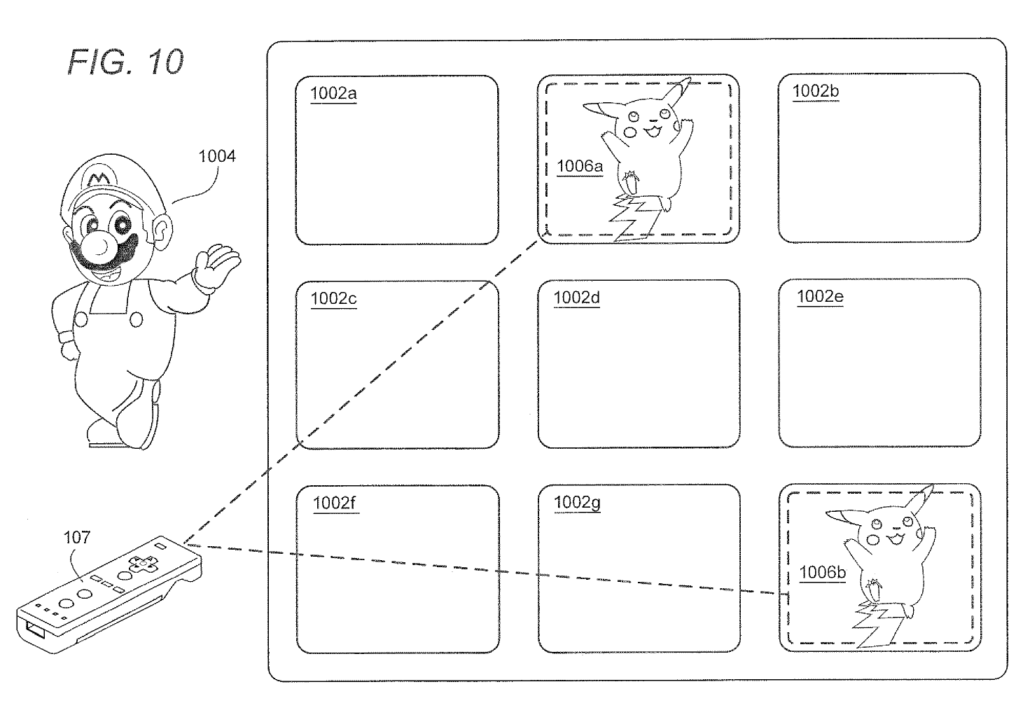

FIG. 10 is an example tile-matching learning game in accordance with an exemplary illustrative embodiment. This game may help a child improve memory skills. In classic concentration style games, a series of tiles or panels 1002a-g are presented to a player. The player then attempts to match the images located “behind” the tiles.

Non-player object 1004 may act as a host. Specifically, non-player object 1004 may be animated so as to “reveal” a tile when a player selects one. Non-player object 1004 also may help the game player if the game player becomes stuck or cannot match tiles.

In this case, matching characters are hidden behind the tiles 1006a-b. The characters shown in the tiles may provide an encouraging sound to the player and/or an exciting animation. For example, in this case, the character Pikachu may say “Pika-Pika” jauntily. However, if Pikachu were matched with a non-Pikachu tile, Pikachu may become “electrified” as is known from the television show Pokemon. It will be appreciated that these examples are provided by way of example and without limitation. It also will be appreciated that the examples given above are based on the actions typical of the characters shown in television cartoons, thus connecting a familiar entertainment channel (e.g., television) with memory-building (e.g., the edutainment game).

2.5 Exemplary Illustrative Maze Learning Game

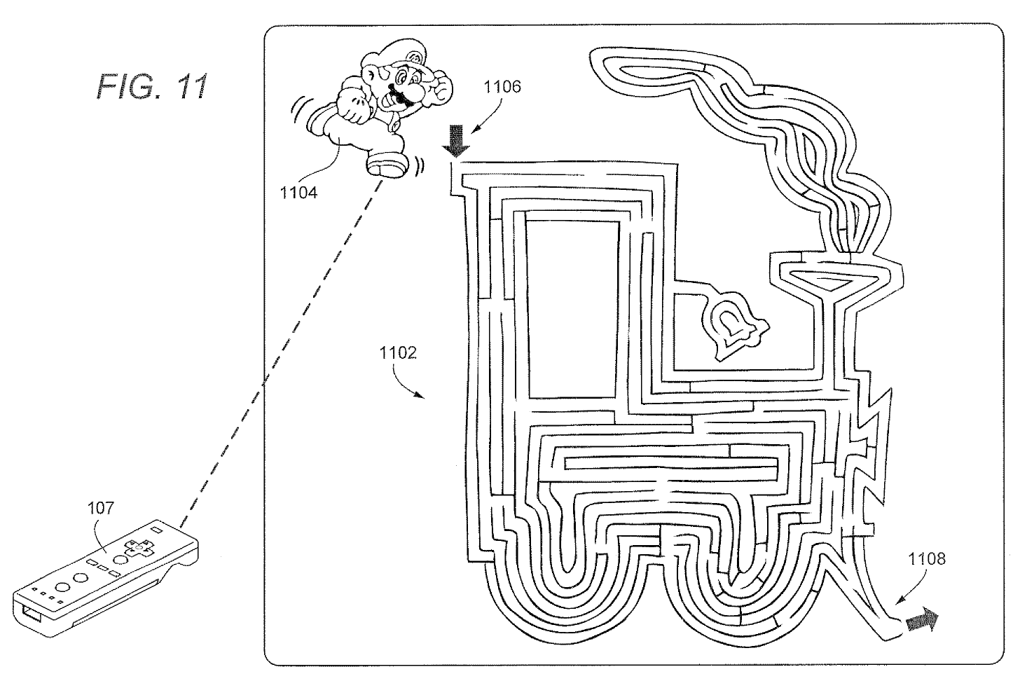

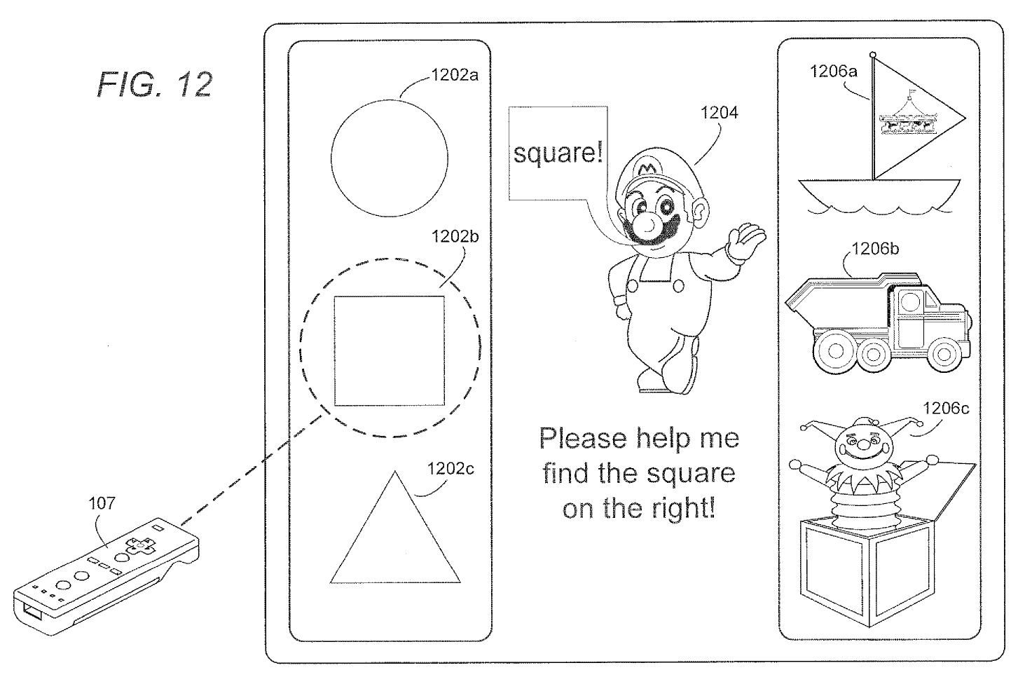

FIG. 11 is an example maze learning game in accordance with an exemplary illustrative embodiment. This game may help a child focus on paths and path-finding and also teach persistence and problem-solving.

Maze 1102 is provided, and the game player may control player character 1104 through maze 1102, from start 1106 to end 1108, using controller 107. The path that the player object 1104 takes through maze 1102 may be displayed on the screen, with the path being updated as the player object 1104 is moved.

It will be appreciated that other maze shapes may be used. It also will be appreciated that player object 1104 may encounter one or more challenges (e.g., mini-games, either educational, entertaining or the like) along his track. Furthermore, these challenges may be kinds of edutainment games in and of themselves. For example, a game player may encounter a roadblock and have to solve a tile-matching game as described above. Furthermore, in certain exemplary illustrative embodiments, the game player may navigate through a three-dimensional maze using a first-person point of view.

2.6 Exemplary Illustrative Shape-Matching Learning Game

FIG. 12 is an example shape-matching game in accordance with an exemplary illustrative embodiment. This game may help a child recognize shapes within more complex objects. It also may teach a child about rotation of objects, sizes, perspective, etc.

A series of shapes are provided on the left-hand side of the screen—namely, circle 1202a, square 1202b, and triangle 1202c. Non-player object 1204 asks the player to help non-player object 1204 locate a particular object that the game player has selected. In this case, non-player object 1204 asks the player to find a square from amongst the complicated figures presented on the right side of the screen. The complicated objects on the right-hand side include sailboat 1206a, dump truck 1206b, and jack-in-the-box 1206c.

As can be appreciated from the figures, sailboat 1206a includes a large triangular mast, dump truck 1206b includes concentric circles as wheels and a circular door window, and the sides of jack-in-the-box 1206c are substantially square. Thus, the player most appropriately would select jack-in-the-box 1206c in this example. Non-player object 1204 may indicate whether a choice was correct, and an animation may show where the particular shapes are located.

In certain exemplary illustrative embodiments, a player additionally may have to place the shapes onto the objects in the appropriate positions. This may involve rotations, scaling, etc. It will be appreciated that any number and kind of shapes and/or complex objects may be presented. For example, three-dimensional shapes such as, for example, cones, cylinders, spheres, etc. may be presented as the simple objects.

The above-described games are only exemplary in both their actual functioning as well as the scope of the games that can be provided. For example, multiple players could play a similar game, either cooperatively or competitively. For example, with the use of the simplified controller, a simplified and educational version of the popular game “Mario Party” available from Nintendo may be provided. Such games could be played with friends, family members, etc.

3. Exemplary Illustrative Edutainment Games Including Navigation in and/or Interaction, Optionally with a Three-Dimensional Virtual Environment

One unique feature of the controller 107 described above is that it may provide a mechanism for controlling a player character and/or objects in a virtual world in a full six degrees of freedom. Thus, the controller 107 is particularly well-suited for enabling navigation through and/or interaction with a three-dimensional virtual environment or world. Because of this unique capability, the game player can more effectively be made to control the player character and/or objects. For example, the player character may move in the virtual world with the corresponding movements of the game player, at least as detected by the controller 107.

Thus, certain exemplary illustrative embodiments may leverage the six degree of freedom form of control to allow movement in and/or interaction with a three-dimensional virtual world to cultivate gross and/or fine motor skills and/or offer unique learning opportunities for game players. Certain illustrative non-limiting types of edutainment games particularly well-suited for this kind of movement and interaction and/or particularly well-suited for conveying novel developmental and/or learning opportunities to children will now be described. Of course, it will be appreciated that the same are provided by way of example and without limitation. Numerous modifications, enhancements, etc. may be made.

3.1 Exemplary Illustrative Daily Activities

Certain exemplary illustrative embodiments may enable game players to guide player characters through daily activities, tasks, or chores. As will be described in greater detail below, in some non-limiting cases, the player character may be a virtual simulation of the game player such that a first-person view in a three-dimensional virtual world enables the game player to “become” the player character. Moreover, in certain exemplary illustrative embodiments, familiar characters may be used to represent the game player (e.g., familiar Nintendo characters, television and/or licensed cartoon characters such as Pikachu, Dora the Explorer, Bob the Builder, etc.). In certain other exemplary illustrative embodiments, an optionally customizable avatar more closely representing the game player may be used instead of a predetermined character.

Daily activities may be grouped, for example, into morning, afternoon, and/or evening tasks, or some other way. A game player (and thus a player character) may be led through a hypothetical day. Alternatively or in addition, a player may have to choose from among a number of activities thereby teaching, for example, appropriateness of when tasks should be completed, responsibility, time management skills, etc.

3.1.1 Waking-Up Examples

Morning tasks may include waking up and/or getting out of bed. In such a case, reading and responding to an alarm may help teach time, for example, by requiring interpretation and processing of a digital and/or analog clock.

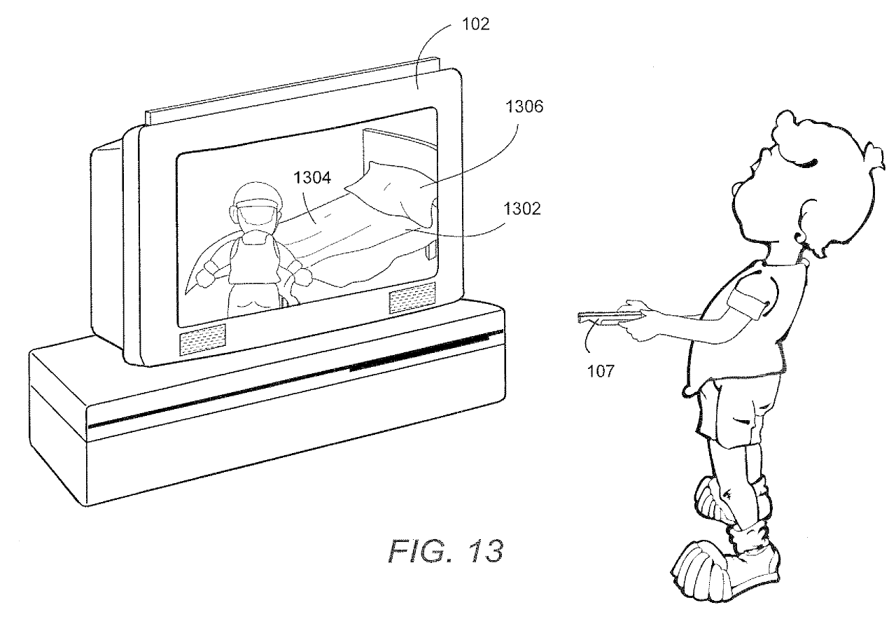

After a player character wakes up, the game player may be instructed to make the bed. FIG. 13 is an example bed-making game in accordance with an exemplary illustrative embodiment. The game player may use the controller 107 to “grab” the sheets 1302 (e.g., by moving the player character's hand and using the trigger button to “grab”) and/or blankets of a bed and then “drag” them across the bed (e.g., by moving the controller 107 until the trigger button ultimately is released to “drop” the item). Wrinkles 1304 may be smoothed, e.g., with slow, controlled substantially horizontal movements, etc. Pillows 1306 may be “fluffed,” e.g., by moving multiple controllers 107 or by moving a controller 107 and a controller attachment together and apart, in sequence. Of course, other parts of making a bed may be required and the particular movements for causing such steps to be performed may be varied from the particular examples provided herein.

3.1.2 Personal Care Examples

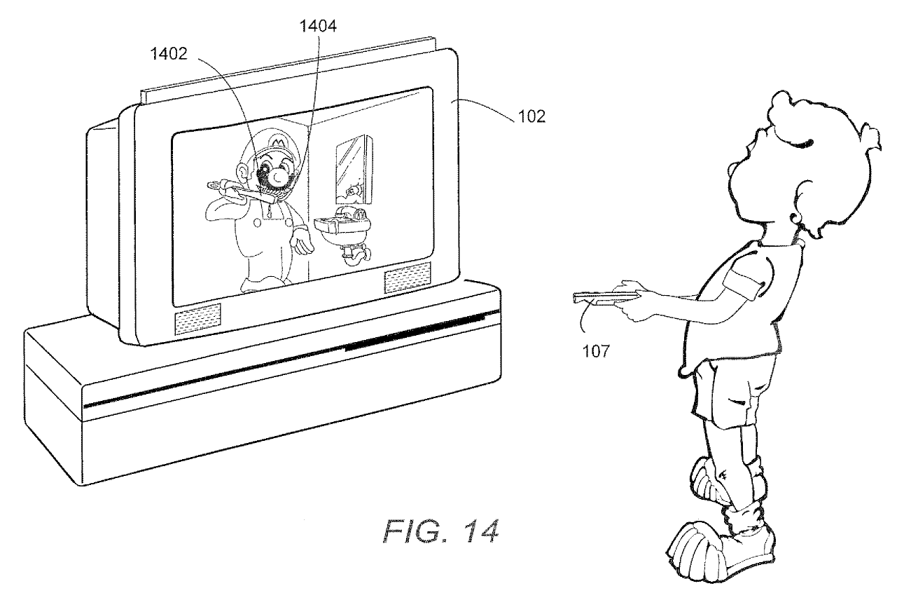

Personal care and/or hygiene lessons also may be taught by certain exemplary illustrative embodiments. For example, a game player may be required to wash the face and/or brush the teeth of the player character, for example, to teach good hygiene, etc. FIG. 14 is an example tooth-brushing game in accordance with an exemplary illustrative embodiment. In the tooth-brushing example, the movement of the controller 107 may cause a corresponding movement of a toothbrush 1402 on the screen. Left-right and/or up-down movements may be shown. When the mouth 1404 opens, forward/backward movement may be enabled. Also, the inclination angle may be detected and/or accounted for, for example, to reach back molars and thus differentiate from canines, etc. Speed of brushing and/or individual strokes also may be detected and/or processed by the game program. In certain exemplary illustrative embodiments, the displayed teeth 1402 may become “cleaner” (e.g., whiter) as the brushing occurs in an individual session, over multiple sessions, etc.

3.1.3 Family Member Interaction Examples

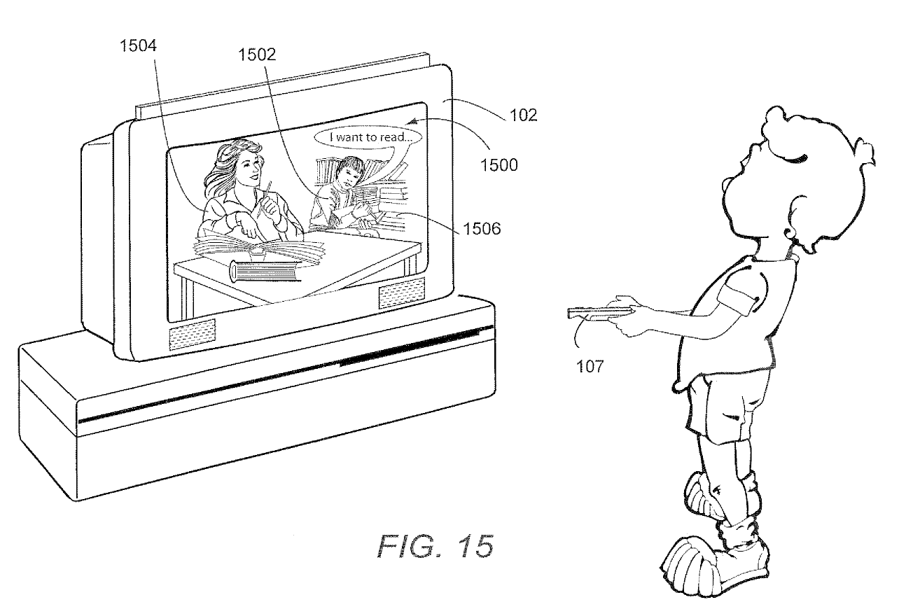

Throughout a hypothetical day, a player character may have interactions with one or more “family members.” These interactions may be centered around teaching lessons. FIG. 15 is an example reading game in accordance with an exemplary illustrative embodiment. For example, a player character may enter a library or living room 1500 of a house and see books 1506 on a shelf. The game player may then select a book with which the player character 1502 may read along with the family member 1504. For example, the words of a story may be displayed on a screen as the family member 1504 reads. Then, the game player may be prompted to verbalize a word, select text corresponding to a word pronounced by the family member 1504, etc. Thus, it may be possible to provide reading lessons to a game player. For example, lessons may be centered around phonies skills, the Stevenson method, etc.

3.1.4 Animal Care Examples

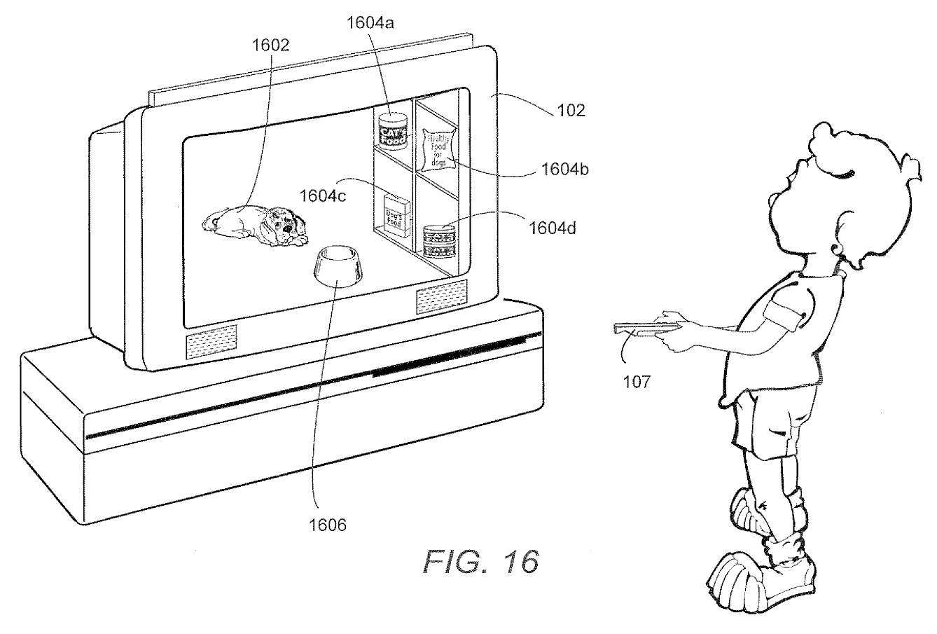

Other lessons may relate to the care of animals and/or pets. For example, a game player may be required to select the correct type of food and/or quantity of food for a particular animal FIG. 16 is an example pet feeding game in accordance with an exemplary illustrative embodiment. To this end, an animal 1602 may be displayed, along with several types of animal food 1604a-d and a bowl 1606 into which the food is to be deposited. The game player may cause the player character to “grab” an appropriate food container 1604a-d using the controller 107, “scoop” or “pour” some of the food into the bowl 1606, and then encourage the animal 1602 to eat. If, for example, the wrong food is chosen, the animal may refuse to eat it, become angry, become sick, etc. If, not enough of the correct food is provided, the animal may become hungry, angry, etc. From the foregoing description, it will be appreciated that other possible scenarios and corresponding reactions are contemplated herein. Thus, the game player may learn to identify animals, read labels on food containers, associate animals with the types of food that they are inclined to eat, learn portion control lessons, etc.

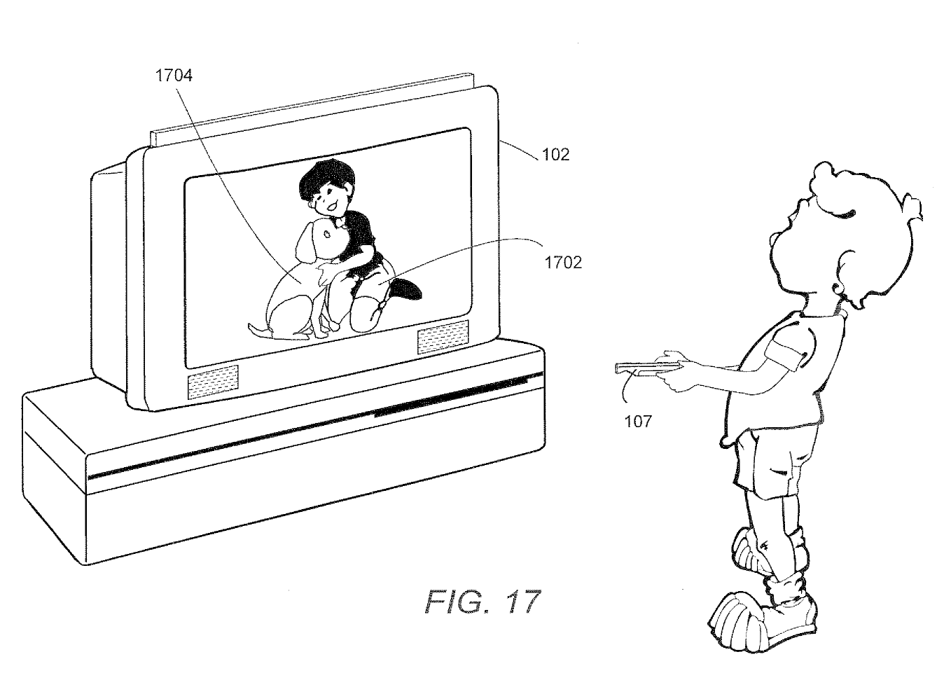

In addition to the animal feeding example, other animal care lessons may be provided. For example, a game player may cause the player character to loving pet or stroke an animal when it behaves or to punish an animal when it misbehaves. In the example shown in FIG. 17, the game player may cause the player character 1702 to kneel (e.g., by pointing the controller 107 downward, actually kneeling, etc.), and then hug the animal 1704 using a corresponding motion with the controller 107. In the former case, for example, when a dog is behaving properly, the game player may cause the player character to scratch the dog behind the ears, rub its belly, etc. Here, striking the dog on the nose would be inappropriate. However, in the latter case, it may be appropriate to discipline the dog, for example, for chewing on the carpet or eating the player character's homework. Positive feedback may be provided on the part of the animal such as, for example, a dog wagging its tail, a cat purring, a bird cooing, etc. Negative feedback may be provided to the game player if, for example, it wrongly punishes the animal, inappropriately pets the animal, etc.

Additional examples, including bathing an animal, checking it for ticks, etc. also may be provided.

3.1.5 Gardening Examples

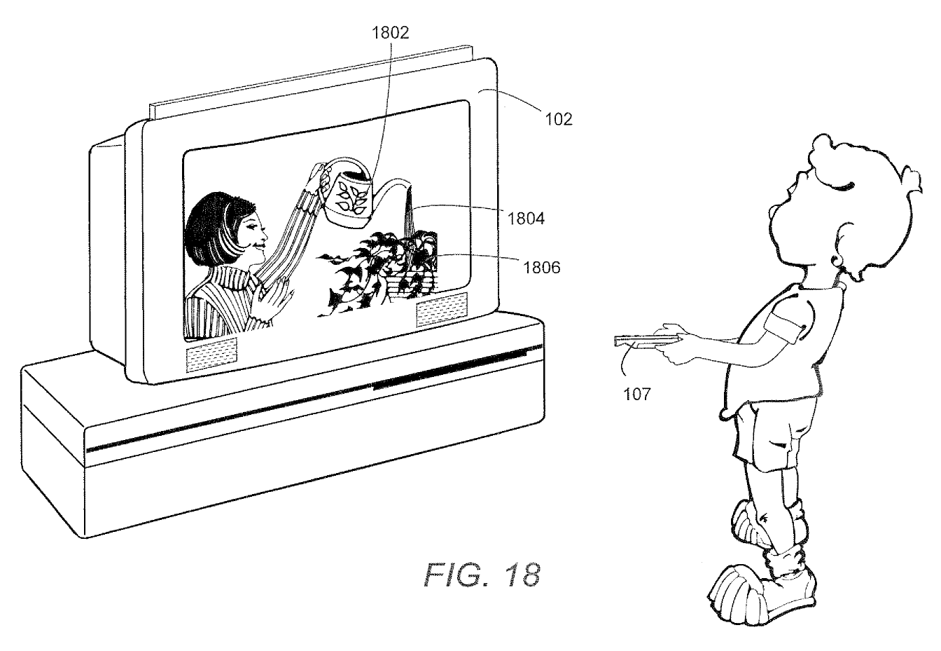

The game player may engage in gardening and/or other horticultural activities. For example, the game player may engage in gardening by watering plants within a home, as is shown in FIG. 18. A number of plants 1806 may be shown on the screen. The player character may hold a pitcher 1802 of water with which the game player may cause the player character to water the plants 1806. The pitcher 1802 may include lines or markings (not shown) to indicate how much water is in the vessel, how much should be deposited in a given plant, etc. The same or similar information may be provided on a separate scale presented to the game player. The game player may tilt the controller 107 to cause water to fall from the pitcher 1802 to the plant 1806. The angular direction may affect the rate at which water 1804 flows. The position in real space may affect whether water 1804 is spilled, what part of the plant 1806 the water falls on, etc. The game player may then be introduced to the concepts of maintenance of plants, different requirements for different plants (e.g., bamboo compared to cacti, etc.), and/or other related lessons.

Similarly, the game player may undertake such activities in a full garden. In such a case, the game player may be responsible for distinguishing between plants and weeds, removing weeds, spreading mulch, etc. Potting, planting, and like services also may be provided.

These basic gardening and/or horticultural lessons may be expanded yet further. For example, garden design, landscaping, flower arrangement (e.g., ikebana, etc.), and/or other opportunities may be provided. In fact, an entire home could be designed and/or constructed in this and/or other ways.

3.2 Exemplary Illustrative Object Manipulation

The game player also may cause the player character to move objects within the virtual environment. Objects may be easily moved across the display by grabbing, which be enabled literally by having the game player squeeze the controller 107, and then dropping them into place by releasing the grip. In his way, applications such as cleaning up a messy room, painting, sculpting, etc. may be provided. In the course of such interaction, the game player may learn about sounds (e.g., one object scraping against another), shapes (e.g., fitting objects into holes, on shelves, in drawers, etc.), colors (e.g., via a painter's palette), numbers, etc.

3.3 Exemplary Illustrative Family Outings

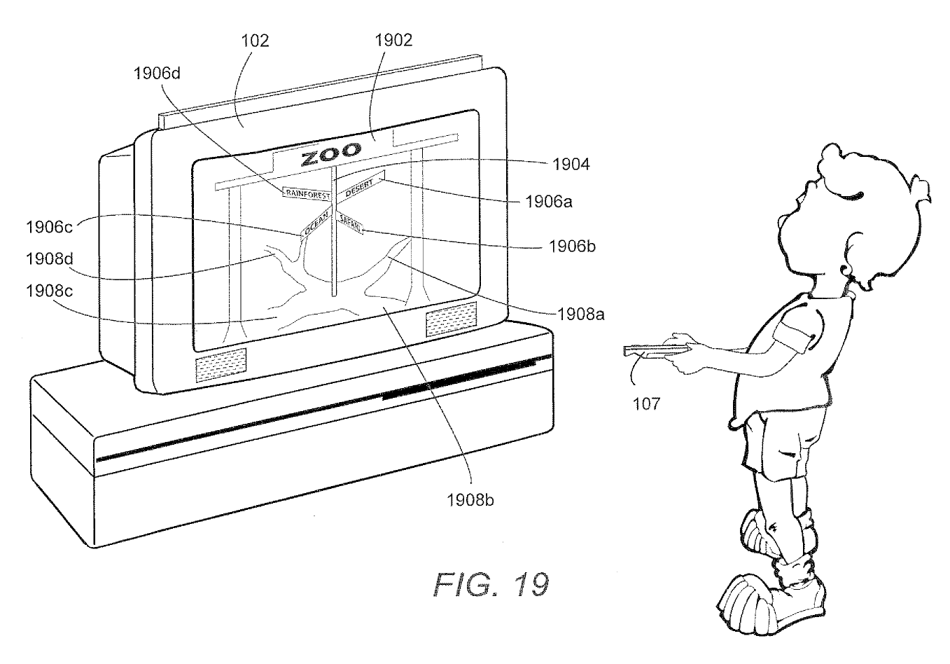

Other games may be provided around the theme of family outings. For example, FIG. 19 is an example zoo outing game in accordance with an exemplary illustrative embodiment. In FIG. 19, the player character is present at the gate 1902 of a zoo. A signpost 1904 includes signs for a desert 1906a, a safari 1906b, the ocean 1906c, and the rainforest 1906d. The game player may cause the player character to take a corresponding path 1908a-d to, for example, learn more about a particular area and/or the animals located therein. Alternatively, the game player may be prompted to take a particular path, for example, by being shown an animal indigenous to the area, by hearing a sound of an animal indigenous to the area, etc.

Other outings may include trips to an amusement park (e.g., to learn about safety, gravity, etc.) or a camping expedition (e.g., to learn about the outdoors, pitching a tent, making a fire, etc.). In each of these cases, the game player be prompted to use the controller 107 on an object to cause a result centered around a skill (e.g., lighting a fire) or knowledge (e.g., fire is hot).

Various techniques for controlling the graphical user interface of the game program may be enabled. For example, a large cursor (e.g., in the form of a hand, cross-hair, glowing ball or spherical object, etc.) may be provided. The game program may synchronously track and output to the display movement of the controller. To select an object, for example, it may be possible to simply use the trigger or button (e.g., by squeezing it once) to pick it up and then again to put it down. Alternatively or in addition, a squeeze and release combination may be enabled to provide the same or similar “drag-and-drop” functionality.

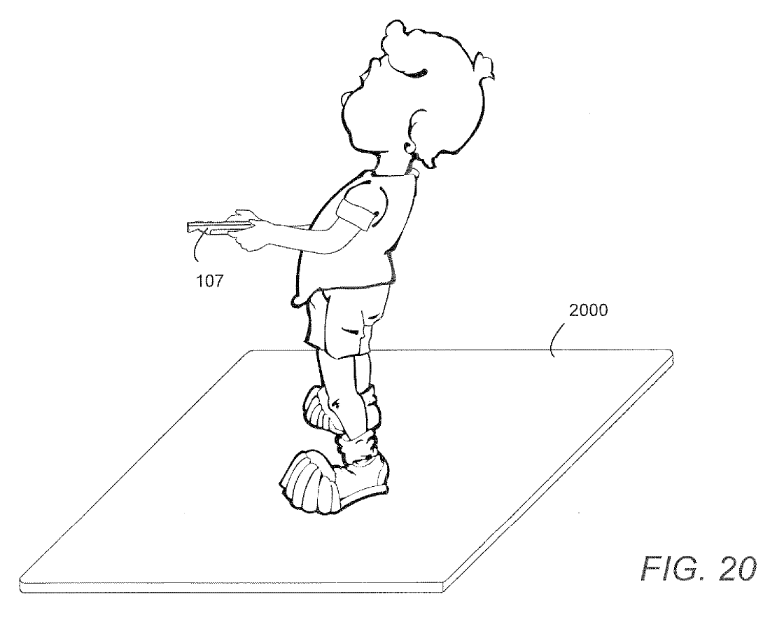

Optionally, additional hardware may be provided for allowing the game player to interact with the virtual environment. In one non-limiting implementation, a direction motion pad 2000 may be provided to enable, for example, player character movement, jumping, running, kicking, etc., e.g., as shown in FIG. 20. Thus, it is possible to provide the benefits of the gross motor skills in addition to arm and hand movements provided by the controller 107. It also is possible to allow the game player to walk in place to simulate movement of the player character, to turn, etc. for a more lifelike, healthy, and educational experience on the whole.

In these and other ways, young children and/or persons with disabilities (e.g., developmental impairments, physical disabilities, mental disabilities, etc.) may be provided with one or more learning tools. Such learning tools may emphasize skills including, for example, color, shape, and/or sound recognition; puzzle-solving; navigation; number recognition, counting, and/or ordering; alphabet; and reading/writing, etc. These skills may be emphasized individually or in various combinations. It will be appreciated that the above-listed skills are given by way of example and without limitation. Developmental movements including, for example, gross and/or fine motor skills may be cultivated as a part of the learning skills or as a skill in and of itself.

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the scope of the appended claims.

What is claimed is:

1. A game system capable of executing a game program stored on a computer readable storage medium, the game system comprising:
a stationary display configured to display output from the game program; and
a handheld pointing controller configured to detect an orientation thereof and configured to provide indirect user interaction with a simplified graphical user interface displayed on the display,
wherein the controller is easily manipulable and includes at least one button or trigger,
wherein the user interaction includes game object selection and/or manipulation from a plurality of user locations and/or perspectives proximate to the display,
wherein the controller is operable substantially only with a gross motor movement of the user, and
wherein the game program is arranged so as to convey to the user at least one lesson or skill.

2. The game system of claim 1, wherein the controller includes exactly one button or trigger.

3. The game system of claim 1, wherein the game program is arranged so as to supply a three-dimensional game space.

4. The game system of claim 1, wherein the game program is operable at least in part in a first-person point of view.

5. The game system of claim 1, wherein the game program and/or the graphical user interface thereof is configured to synchronously track and output to the display movement of the controller.

6. The game system of claim 1, wherein the location is below the display level.

7. The game system of claim 6, wherein the controller is pointed in an upward direction.

8. The game system of claim 1, wherein the controller is configured to be manipulated using a developmental movement.

9. The game system of claim 1, wherein the user is a toddler or a person with a disability.

10. The game system of claim 1, wherein the at least one lesson or skill involves a phonetic matching game.

11. The game system of claim 1, wherein the at least one lesson or skill involves a number matching game.

12. The game system of claim 1, wherein the at least one lesson or skill involves a daily activity, task, or chore.

13. A computer-readable storage medium tangible embodying a game program for use with a game system having a handheld pointing controller configured to detect an orientation thereof the game program comprising:
display programmed logic circuitry configured to display output from the game program to a stationary display; and
controlling programmed logic circuitry configured to receive input from the controller and configured to provide indirect user interaction with a simplified graphical user interface of the game program displayable on the display,
wherein the controller is easily manipulable and includes at least one button or trigger,
wherein the user interaction includes game object selection and/or manipulation from a plurality of user locations and/or perspectives proximate to the display,
wherein the controller is operable substantially only with a gross motor movement of the user, and
wherein the game program is arranged so as to convey to the user at least one lesson or skill.

14. The storage medium of claim 13, wherein the controller includes exactly one button or trigger.

15. The storage medium of claim 13, wherein the game program is arranged so as to supply a three-dimensional game space.

16. The storage medium of claim 13, wherein the game program is operable at least in part in a first-person point of view.

17. The storage medium of claim 13, wherein the game program and/or the graphical user interface thereof is configured to synchronously track and output to the display movement of the controller.

18. The storage medium of claim 13, wherein the location is below the display level.

19. The storage medium of claim 18, wherein the controller is pointed in an upward direction.

20. The storage medium of claim 13, wherein the controller is configured to be manipulated using a developmental movement.

21. The game system of claim 13, wherein the user is a toddler or a person with a disability.

22. The game system of claim 13, wherein the at least one lesson or skill involves a phonetic matching game.

23. The game system of claim 13, wherein the at least one lesson or skill involves a number matching game.

24. The game system of claim 13, wherein the at least one lesson or skill involves a daily activity, task, or chore.

25. A method of playing a game on a game system having a handheld pointing controller that is easily manipulable, includes at least one button or trigger, and is configured to detect its own orientation, the method comprising:
displaying a simplified graphical user interface on a stationary display;
receiving input from the controller;
providing indirect user interaction with the simplified graphical user interface on the display,
selecting game objects in response to said controller positioned vertically below and aimed upwardly toward the display,
wherein the game is capable of effectively teaching a toddler less than five years old at least one lesson or skill.
